(19) United States
(12) Patent Application Publication
(10) Pub. No.: US 2014/0028842 A1
(43) Pub. Date: Jan. 30, 2014

(54) CALIBRATION DEVICE AND METHOD FOR USE IN A SURVEILLANCE SYSTEM FOR EVENT DETECTION

(71) Applicants: Haggai Abramson, Ramat Gan (IL); Shay Leshkowitz, Yehud (IL); Dima Zusman, Beer Sheva (IL); Zvi Ashani, Ganei Tikva (IL)

(72) Inventors: Haggai Abramson, Ramat Gan (IL); Shay Leshkowitz, Yehud (IL); Dima Zusman, Beer Sheva (IL); Zvi Ashani, Ganei Tikva (IL)

(73) Assignee: AGENT VIDEO INTELLIGENCE LTD., Rosha Ha'ayin (IL)

(21) Appl. No.: 13/978,030

(22) PCT Filed: Dec. 22, 2011
(86) PCT No.: PCT/IL2011/050073

§ 371 Date: Oct. 11, 2013

(30) Foreign Application Priority Data
Jan. 2, 2011 (IL) 210427

(51) Int. Cl. H04N 7/18

(52) U.S. Cl. CPC H04N 7/18
USPC 348/143

(57) ABSTRACT

A calibration device is presented for use in a surveillance system for event detection. The calibration device comprises an input utility for receiving data indicative of an image stream of a scene in a region of interest acquired by at least one imager and generating image data indicative thereof, and a data processor utility configured and operable for processing and analyzing said image data, and determining at least one calibration parameter including at least one of the imager related parameter and the scene related parameter.

### FIELD OF THE INVENTION

This invention is in the field of automated video surveillance systems, and relates to a system and method for calibration of the surveillance system operation.

### BACKGROUND OF THE INVENTION

Surveillance systems utilize video cameras to observe and record occurrence of events in a variety of indoor and outdoor environments. Such usage of video streams requires growing efforts for processing the streams for effective events' detection. The events to be detected may be related to security, traffic control, business intelligence, safety and/or research. In most cases, placing a human operator in front of a video screen for “manual processing” of the video stream would provide the best and simplest event detection. However, this task is time consuming. Indeed, for most people, the task of watching a video stream to identify event occurrences for a time exceeding 20 minutes was found to be very difficult, boring and eventually ineffective. This is because the majority of the people cannot concentrate on “not-interesting” scenes (visual input) for a long time. Keeping in mind that most information in a “raw” video stream does not contain important events to be detected, or in fact it might not contain any event at all, the probability that a human observer will be able to continually detect events of interest is very low.

A significant amount of research has been devoted for developing algorithms and systems for automated processing and event detection in video images captured by surveillance cameras. Such automated detection systems are configured to alert human operators only when the system identifies a “potential” event of interest. These automated event detection system therefore reduce the need for continuous attention of the operator and allow a less skilled operator to operate the system. An example of such automatic surveillance system is disclosed in EP 1,459,544 assigned to the assignee of the present application.

The existing systems of the kind specified can detect various types of events, including intruders approaching a perimeter fence or located at specified regions, vehicles parked at a restricted area, crowd formations, and other event types which may be recorded on a video stream produced by surveillance cameras. Such systems are often based on solutions commonly referred to as Video Content Analysis (VCA). VCA-based systems may be used not only for surveillance purposes, but may also be used as a researching tool, for example for long-time monitoring of subject's behavior or for identifying patterns in behavior of crowds.

Large efforts are currently applied in research and development towards making algorithms for VCA-based systems, or other video surveillance systems, in order to improve systems performance in a variety of environments, and to increase the probability of detection (POD). Also, techniques have been developed for reducing the false alarm rates (FAR) in such systems, in order to increase efficiency and decrease operation costs of the system.

Various existing algorithms can provide the satisfying system performance for detecting a variety of events in different environments. However most, if not all, of the existing algorithms require a setup and calibration process for the system operation. Such calibration is typically required in order for a video surveillance system to be able to recognize events in different environments.

For example, U.S. Pat. No. 7,751,589 describes estimation of a 3D layout of roads and paths traveled by pedestrians by observing the pedestrians and estimating road parameters from the pedestrian's size and position in a sequence of video frames. The system includes a foreground object detection unit to analyze video frames of a 3D scene and detect objects and object positions in video frames, an object scale prediction unit to estimate 3D transformation parameters for the objects and to predict heights of the objects based at least in part on the parameters, and a road map detection unit to estimate road boundaries of the 3D scene using the object positions to generate the road map.

### GENERAL DESCRIPTION

There is a need in the art for a novel system and method for automated calibration of a video surveillance system.

In the existing video surveillance systems, the setup and calibration process is typically performed manually, i.e. by a human operator. However, the amount of effort required for performing setup and calibration of an automated surveillance system grows with the number of cameras connected to the system. As the number of cameras connected to the system, or the number of systems for video surveillance being deployed, increases, the amount of effort required in installing and configuring each camera becomes a significant issue and directly impacts the cost of employing video surveillance systems in large scales. Each camera has to be properly calibrated for communication with the processing system independently and in accordance with the different scenes viewed and/or different orientations, and it is often the case that the system is to be re-calibrated on the fly.

A typical video surveillance system is based on a server connected to a plurality of sensors, which are distributed in a plurality of fields being monitored for detection of events. The sensors often include video cameras.

It should be noted that the present invention may be used with any type of surveillance system, utilizing imaging of a scene of interest, where the imaging is not necessarily implemented by video. Therefore, the terms “video camera” or “video stream” or “video data” sometimes used herein should be interpreted broadly as “imager”, “image stream”, “image data”. Indeed, a sensor needed for the purposes of the present application may be any device of the kind producing a stream of sequentially acquired images, which may be collected by visible light and/or IR and/or UV and/or RF and/or acoustic frequencies. It should also be noted that an image stream, as referred to herein, produced by a video camera may be transmitted from a storing device such as hard disc drive, DVD or VCR rather than being collected “on the fly” by the collection device.

The server of a video surveillance system typically performs event detection utilizing algorithms such as Video Content Analysis (VCA) to analyze received video. The details of an event detection algorithm as well as VCA-related technique do not form a part of the present invention, and therefore need not be described herein, except to note the following: VCA algorithms analyze video streams to extract foreground object in the form of “blobs” and to separate the foreground objects from a background of the image stream. The event detection algorithms focus mainly on these blobs defining objects in the line of sight of the camera. Such events may include objects, i.e. people, located in an undesired position, or other types of events. Some event detection techniques may utilize more sophisticated algorithms such as face recognition or other pattern recognition algorithms.

Video cameras distributed in different scenes might be in communication with a common server system. Data transmitted from the cameras to the server may be raw or pre-processed data (i.e. video image streams, encoded or not) to be further processed at the server. Alternatively, the image stream analysis may be at least partially performed within the camera unit. The server and/or processor within the camera perform various analyses on the image stream to detect predefined events. As described above, the processor may utilize different VCA algorithms in order to detect occurrence of predefined events at different scenes and produce a predetermined alert related to the event. This analysis can be significantly improved by properly calibrating the system with various calibration parameters, including camera related parameters and/or scene related parameters.

According to the invention, the calibration parameters are selected such that the calibration can be performed fully automatically, while contributing to the event detection performance. The inventors have found that calibration parameters improving the system operation include at least one of the camera-related parameters and/or at least one of the scene-related parameters. The camera-related parameters include at least one of the following: (i) a map of the camera's pixel size for a given orientation of the camera's field of view with respect to the scene being observed; and (ii) angle of orientation of the camera relative to a specified plane in the observed field of view (e.g., relative to the ground, or any other plane defined by two axes); and the scene-related parameters include at least the type of illumination of the scene being observed. The use of some other parameters is possible. The inventors have found that providing these parameters to the system improves the events' detection and allows for filtering out noise which might have otherwise set up an alarm. In addition, provision of the camera-related parameters can enhance classification performance, i.e. improve the differentiation between different types of objects in the scene. It should also be noted that the invention provides for automatic determination of these selected calibration parameters.

Thus, according to one broad aspect of the invention, there is provided a calibration device for use in a surveillance system for event detection, the calibration device comprising an input utility for receiving data indicative of an image stream of a scene in a region of interest acquired by at least one imager and generating image data indicative thereof, and a data processor utility configured and operable for processing and analyzing said image data, and determining at least one calibration parameter including at least one of the imager related parameter and the scene related parameter.

Preferably, the imager related parameter(s) includes the following: a ratio between a pixel size in an acquired image and a unit dimension of the region of interest; and orientation of a field of view of said at least one imager in relation to at least one predefined plane within the region of interest being imaged.

Preferably, the scene related parameter(s) includes illumination type of the region of interest while being imaged. The latter comprises information whether said region of interest is exposed to either natural illumination or artificial illumination. To this end, the processor may include a histogram analyzer utility operable to analyze data indicative of a spectral histogram of at least a part of the image data.

In some embodiments, such analysis of the data indicative of the spectral histogram comprises determining at least one ratio between histogram parameters of at least one pair of different-color pixels in at least a part of said image stream.

The processor utility comprises a parameters' calculation utility, which may include a first parameter calculation module operable to process data indicative of the results of histogram analysis (e.g. data indicative of said at least one ratio). Considering the example dealing with the ratio between histogram parameters of at least one pair of different-color pixels, the parameter calculation module identifies the illumination type as corresponding to the artificial illumination if said ratio is higher than a predetermined threshold, and as the natural illumination if said ratio is lower than said predetermined threshold.

In some embodiments, the data indicative of the ratio between the pixel size and unit dimension of the region of interest comprises a map of values of said ratio corresponding to different groups of pixels corresponding to different zones within a frame of said image stream.

In an embodiment of the invention, the processor utility comprises a foreground extraction module which is configured and operable to process and analyze the data indicative of the image stream to extract data indicative of foreground blobs corresponding to objects in the scene, and a gradient calculation module which is configured and operable to process and analyze the data indicative of said image stream to determine an image gradient within a frame of the image stream. The parameter calculation utility of the processor may thus include a second parameter calculation module operable to analyze the data indicative of the foreground blobs and the data indicative of the image gradient, fit at least one model from a set of predetermined models with at least one of said foreground blobs, and determine at least one camera-related parameter.

The second parameter calculation module may operate for selection of the model fitting with at least one of the foreground blobs by utilizing either a first or a second camera orientation mode with respect to the scene in the region of interest. To this end, the second parameter calculation module may start with the first orientation mode and operate to identify whether there exists a fitting model for the first camera orientation mode, and upon identifying that no such model exists, select a different model based on the second camera orientation mode. For example, deciding about the first or second camera orientation mode may include determining whether at least one of the imager related parameters varies within the frame according to a linear regression model, while being based on the first camera orientation mode, and upon identifying that said at least one imager related parameter does not vary according to the linear regression model, processing the received data based on the second imager orientation mode.

The first and second imager orientation modes may be angled and overhead orientations respectively. The angled orientation corresponds to the imager position such that a main axis of the imager's field of view is at a non-right angle to a certain main plane, and the overhead orientation corresponds to the imager position such that a main axis of the imager's field of view is substantially perpendicular to the main plane.

According to another broad aspect of the invention, there is provided an automatic calibration device for use in a surveillance system for event detection, the calibration device comprising a data processor utility configured and operable for receiving image data indicative of an image stream of a scene in a region of interest, processing and analyzing said image data, and determining at least one calibration parameter including at least one of the imager related parameter and the scene related parameter.

According to yet another broad aspect of the invention, there is provided an imager device (e.g. camera unit) comprising: a frame grabber for acquiring an image stream from a scene in a region of interest, and the above described calibration device.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a block diagram of an auto-calibration device of the present invention for use in automatic calibration of the surveillance system;

FIG. 2 exemplifies operation of a processor utility of the device of FIG. 1;

FIG. 3 is a flow chart exemplifying operation of a processing module in the processor utility of the device of FIG. 1;

FIG. 4 is a flow chart exemplifying a 3D model fitting procedure suitable to be used in the device of the present invention;

FIGS. 5A and 5B illustrate examples of the algorithm used by the processor utility: FIG. 5A shows the rotation angle ρ of an object/blob within the image plane, FIG. 5B shows “corners” and “sides” of a 3D model projection, and FIGS. 5C and 5D show two examples of successful and un-successful model fitting to an image of a car respectively;

FIGS. 6A to 6D shows an example of a two-box 3D car model which may be used in the invention: FIG. 6A shows the model from an angled orientation illustrating the three dimensions of the model, and FIGS. 6B to 6D show side, front or back, and top views of the model respectively;

FIGS. 7A to 7C show three examples respectively of car models fitting to an image;

FIGS. 8A to 8E shows a 3D pedestrian model from different points of view: FIG. 8A shows the model from an angled orientation, FIGS. 8B to 8D show the pedestrian model from the back or front, side and a top view of the model respectively; and FIG. 8E illustrates the fitting of a human model;

FIGS. 9A to 9D exemplify calculation of an overhead map and an imager-related parameter being a ratio between a pixel size in an acquired image and a unit dimension (meter) of the region of interest, i.e. a pixel to meter ratio (PMR) for a pedestrian in the scene: FIG. 9A shows a blob representing a pedestrian from an overhead orientation together with its calculated velocity vector; FIG. 9B shows the blob approximated by an ellipse; FIG. 9C shows identification of an angle between the minor axis of the ellipse and the velocity vector, and FIG. 9D shows a graph plotting the length of the minor axis of the ellipse as a function of the angle;

FIGS. 10A to 10D illustrate four images and their corresponding RGB histograms: FIGS. 10A and 10B show two scenes under artificial lighting, and FIGS. 10C and 10D show two scenes at natural lighting;

FIGS. 11A to 11D exemplify the use of the technique of the present invention for differentiating between different types of objects in an overhead view: FIG. 11A shows an overhead view of a car and its two primary contour axes; FIG. 11B exemplifies the principles of calculation of a histogram of gradients; and FIGS. 11C and 11D show the histograms of gradients for a human and car respectively; and

FIGS. 12A and 12B exemplify the use of the technique of the present invention for differentiating between cars and people.

### DETAILED DESCRIPTION OF EMBODIMENTS

Reference is made to FIG. 1, illustrating, in a way of a block diagram, a device 100 according to the present invention for use in automatic calibration of the surveillance system. The device 100 is configured and operable to provide calibration parameters based on image data typically in the form of an image stream 40, representing at least a part of a region of interest.

The calibration device 100 is typically a computer system including inter alia an input utility 102, a processor utility 104 and a memory utility 106, and possibly also including other components which are not specifically described here. It should be noted that such calibration device may be a part of an imaging device (camera unit), or a part of a server to which the camera is connectable, or the elements of the calibration device may be appropriately distributed between the camera unit and the server, The calibration device 100 receives image stream 40 through the input utility 102, which transfers corresponding image data 108 (according to internal protocols of the device) to the processor utility 104. The latter operates to process said data and to determine the calibration parameters by utilizing certain reference data (pre-calculated data) 110 saved in the memory utility 106. The parameters can later be used in event-detection algorithms applied in the surveillance system, to which the calibration device 100 is connected, for proper interpretation of the video data.

The calibration parameters may include: orientation of the camera relative to the ground or to any other defined plane within the region of interest; and/or pixel size in meters, or in other relevant measure unit, according to the relevant zone of the region of interest; and/or type of illumination of the region of interest. The device 100 generates output calibration data 50 indicative of at least one of the calibration parameters, which may be transmitted to the server system through an appropriate output utility, and/or may be stored in the memory utility 106 of the calibration device or in other storing locations of the system.

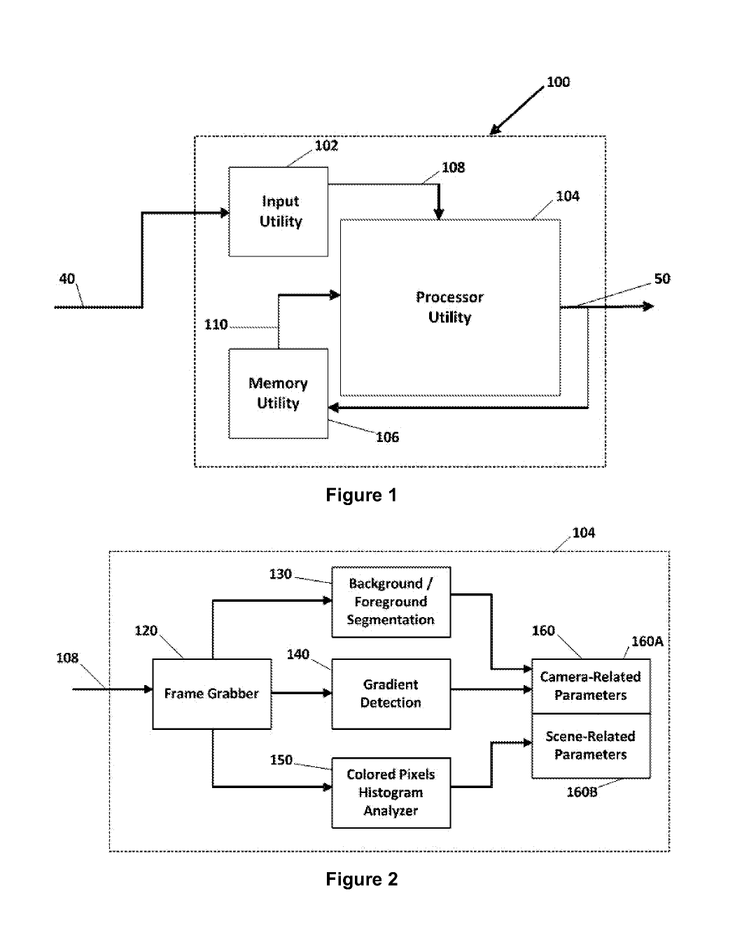

The operation of the processor utility 104 is exemplified in FIG. 2. Image data 108 corresponding to the input image stream 40 is received at the processor utility 104. The processor utility 104 includes several modules (software/hardware utilities) performing different data processing functions. The processor utility includes a frame grabber 120 which captures a few image frames from the image data 108. In the present example, the processor utility is configured for determination of both the scene related calibration parameters and the camera related calibration parameters. However, it should be understood that in the broadest aspect of the invention, the system capability of automatic determination of at least one of such parameters would significantly improve the entire event detection procedure. Thus, in this example, further provided in the processor utility 104 are the following modules: a background/foreground segmentation module 130 which identifies foreground related features; an image gradient detection module 140; a colored pixel histogram analyzer 150, and a parameters' calculation module 160. The latter includes 2 sub-modules 160A and 160B which respond to data from respectively modules 130,140 and module 150 and operate to calculate camera-related parameters and scene-related parameters. Operation of the processing modules and calculation of the scene related parameters will be further described below.

The input of these processing modules is a stream of consecutive frames (video) from the frame grabber 120. Each of the processing modules is preprogrammed to apply different algorithm(s) for processing the input frames to extract certain features. The background/foreground segmentation processing module 130 identifies foreground features using a suitable image processing algorithm (using any known suitable technique such as background modeling using a mixture of Gaussians (as disclosed for example in “Adaptive background mixture models for real-time tracking”, Stauffer, C.; Grimson, W. E. L. IEEE Computer Society Conference, Fort Collins. CO, USA, 23 Jun. 1999-25 Jun. 1999) to produce binary foreground images. Calculation of gradients in the frames by module 140 utilizes an edge detection technique of any known type, such as those based on the principles of Canny edge detection algorithms. Module 150 is used for creation of colored pixels histogram data based on RGB values of each pixel of the frame. This data and color histogram analysis is used for determination of such scene-related parameter as illumination of the region of interest being imaged. It should be noted that other techniques can be used to determine the illumination type. These techniques are typically based on processing of the image stream from the camera unit, e.g. spectral analysis applied to spectrum of image data received. Spectral analysis techniques may be utilized for calibrating image stream upon imaging using visible light, as well as IR, UV, RF, microwave, acoustic or any other imaging technique, while the RBG histogram can be used for visible light imaging.

The processing results of each of the processing modules 130, 140 and 150 are further processed by the module 160 for determination of the calibration parameters. As indicated above, the output data of 130 and 140 is used for determination of camera related parameters, while the output data of module 150 is used for determination of the scene related parameters.

The camera-related parameters are determined according to data pieces indicative of at least some of the following features: binary foreground images based on at least two frames and gradients in the horizontal and vertical directions (x, y axes) for one of the frames. In order to facilitate understanding of the invention as described herein, these two frames are described as “previous frame” or i-th frame in relation to the first captured frame, and “current frame” or (i+1)-th frame in relation to the later captured frame.

As for the scene-related parameters, they are determined from data piece corresponding to the pixel histogram in the image data.

It should be noted that a time slot between the at least two frames, i.e. previous and current frames and/or other frames used, need not be equal to one frame (consecutive frames). This time slot can be of any length, as long as one or more moving objects appear in both frames and provided that the objects have not moved a significant distance and their positions are substantially overlapping. It should however be noted that the convergence time for calculation of the above described parameters may vary in accordance with the time slot between couples of frames, i.e. the gap between one pair of i-th and (i+1)-th frames and another pair of different i-th and (i+1)-th frames. It should also be noted that a time limit for calculation of the calibration parameters may be determined in accordance with the frame rate of the camera unit and/or the time slot between the analyzed frames.

In order to refine the input frames for the main processing, the processor utility 104 (e.g. the background/foreground segmentation module 130 or an additional module as the case may be) might perform a pre-process on the binary foreground images. The module 130 operates to segment binary foreground images into blobs, and at the pre-processing stage the blobs are filtered using the filtering algorithm based on a distance between the blobs, the blob size and its location. More specifically: blobs that have neighbors closer than a predetermined threshold are removed from the image; blobs which are smaller than another predetermined threshold are also removed; and blobs that are located near the edges of the frame (i.e. are spaced therefrom a distance smaller than a third predetermined threshold) are removed. The first step (filtering based on the distance between the blobs) is aimed at avoiding the need to deal with objects whose blobs, for some reason, have been split into smaller blobs, the second pre-processing step (filtering based on the blob size) is aimed at reducing the effects of noise, while the third step (filtering based on the blob location) is aimed at ignoring objects that might be only partially visible, i.e. having only part of them within the field of view.

After the blobs have been filtered, the processor may operate to match and correlate between blobs in the two frames. The processor 104 (e.g. module 160) actually identifies blobs in both the previous and the current frames that represent the same object. To this end, the processor calculates an overlap between each blob in the previous frame (blob A) and each blob in the current frame (blob B). When such two blobs A and B are found to be highly overlapping, i.e. overlap larger than a predetermined threshold, the processor calculates and compares the aspect ratio of the two blobs. Two blobs A and B have a similar aspect ratio if both the minimum of the width (W) of the blobs divided by the maximum of the width of them, and the minimum of the height (H) divided by the maximum of the height are greater than a predetermined threshold, i.e., if equation 1 holds.

$$( \frac{min ( {W}_{A} , {W}_{B} )}{max ( {W}_{A} , {W}_{B} )} > Th ) ⋂ ( \frac{min ( {H}_{A} , {H}_{B} )}{max ( {H}_{A} , {H}_{B} )} > Th ) \qquad ( eqn . 1 )$$

This procedure is actually a comparison between the blobs, and a typical value of the threshold is slightly below 1. The blob pairs which are found to have the largest overlap between them and have similar aspect ratio according to equation 1 are considered to be related (i.e. of the same object).

Then, the processing module 160 operates to calculate the size of pixels in any relevant zone in the region of interest as presented in length units (e.g. meters), and the exact angle of orientation of the camera. This is carried out as follows: The module projects predetermined 3D models of an object on the edges and contour of object representation in the image plane. In other words, the 3D modeled object is projected onto the captured image. The projection is applied to selected blobs within the image.

Preferably, an initial assumption with respect to the orientation of the camera is made prior to the model fitting process, and if needed is then optimized based on the model fitting results, as will be described below. In this connection, the following should be noted. The orientation of the camera is assumed to be either angled or overhead orientation. Angled orientation describes a camera position such that the main axis/direction of the camera's field of view is at a non-zero angle (e.g. 30-60 degrees) with respect to a certain main plane (e.g. the ground, or any other plane defined by two axes). Overhead orientation describes an image of the region of interest from above, i.e. corresponds to the camera position such that the main axis/direction of the camera's field of view is substantially perpendicular to the main plane. The inventors have found that angled orientation models can be effectively used for modeling any kind of objects, including humans, while the overhead orientation models are less effective for humans. Therefore, while the system performs model fitting for both angled and overhead orientation, it first tries to fit a linear model for the pixel-to-meter ratios calculated in different location in the frame, a model which well describes most angled scenarios, and only if this fitting fails the system falls-back to the overhead orientation and extracts the needed parameters from there. This procedure will be described more specifically further below.

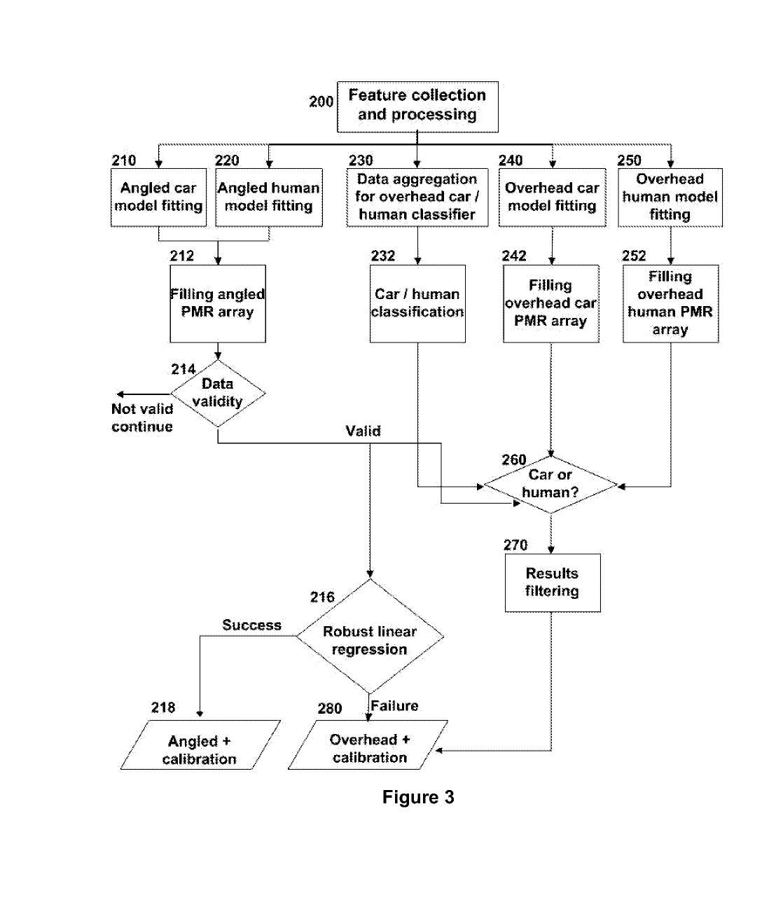

Reference is made to FIG. 3 showing a flow chart describing an example of operation of the processing module 160A in the device according to the present invention. Input data to module 160A results from collection and processing of the features of the image stream (step 200) by modules 130 and 140 as described above. Then, several processes may be applied to the input data substantially in parallel, aimed at carrying out, for each of the selected blobs, model fitting based on angled camera orientation and overhead camera orientation, each for both “car” and “human” models (steps 210, 220, 240 and 250). More specifically, the camera is assumed to be oriented with an angled orientation relative to the ground and the models being fit are a car model and a human model (steps 210 and 220). The model fitting results are aggregated and used to calculate pixel to meter ratio (PMR) values for each object in the region of the frame where the object at hand lies.

The aggregated data resulted from the model fitting procedures includes different arrays of PMR values: array A₁ including the PMR values for the angled camera orientation, and arrays A₂ and A₃ including the “car” and “human” model related PMR values for the overhead camera orientation. These PMR arrays are updated by similar calculations for multiple objects, while being sorted in accordance with the PMR values (e.g. from the minimal towards the maximal one). The PMR arrays are arranged/mapped in accordance with different groups of pixels corresponding to different zones within a frame of the image stream. Thus, the aggregated data includes “sorted” PMR arrays for each group of pixels.

Then, aggregated data (e.g. median PMR values from all the PMR arrays) undergoes further processing for the purposes of validation (steps 212, 242, 252). Generally speaking, this processing is aimed at calculating a number of objects filling each of the PMR arrays, based on a certain predetermined threshold defining sufficient robustness of the system. The validity check (step 214) consists of identifying whether a number of pixel groups with the required number of objects filling the PMR array satisfies a predetermined condition. For example, if it appears that such number of pixel groups is less than 3, the aggregated data is considered invalid. In this case, the model selection and fitting processes are repeated using different models, and this proceeds within certain predetermined time limits.

After the aggregated data is found valid, the calibration device tries to fit a linear model (using linear regression) to the calculated PMR's in the different location in the frame (step 216). This process is then used for confirming or refuting the validity of the angled view assumption. If the linear regression is successful (i.e. yields coefficient of determination close to 1), the processing module 160A determines the final angled calibration of the camera unit (step 218) as well as also calculates the PMR parameters for other zones of the same frame in which a PMR has not been calculated due to lack of information (low number of objects in the specific zones). If the linear regression fails (i.e. yields a coefficient of determination value lower than a predefined threshold), the system decides to switch to the overhead orientation mode.

Turning back to the feature collection and processing stage (step 200), in parallel to the model fitting for angled and overhead camera orientations and for “car” and “human” models (steps 210, 220, 240 and 250), the processor/module 160A operates to calculate a histogram of gradient (HoG), fit an ellipse and calculate the angle between each such ellipse's orientation and the motion vector of each blob. It also aggregates this data (step 230) thereby enabling initial estimation about car/human appearance in the frame (step 232).

Having determined that the data from the angled assumption is valid (step 214), and then identifying that the linear regression procedure fails, the overhead-orientation assumption is selected as the correct one, and then the aggregated HoG and the ellipse orientation vs. motion vector differences data is used to decide whether the objects in the scene are cars or humans. This is done under the assumption that a typical overhead scene includes either cars or humans but not both. The use of aggregating process both for the overhead and the angled orientation modes provides the system with robustness. The calculation of histogram of gradients, ellipse orientation and the model fitting procedures will be described more specifically further below.

The so determined parameters are filtered (step 270) to receive overhead calibration parameters (step 280). The filtering process includes removal of non-valid calculations, performing spatial filtering of the PMR values for different zones of the frame, and extrapolation of PMR for the boundary regions between the zones.

It should be understood that the technique of the present invention may be utilized for different types of surveillance system as well as for other automated video content analysis systems. Such systems may be used for monitoring movement of humans and/or vehicles as described herein, but may also be used for monitoring behavior of other objects, such as animals, moving stars or galaxies or any other type of object within an image frame. The use of the terms “car”, or “human” or “pedestrian”, herein is to be interpreted broadly and include any type of objects, manmade or natural, which may be monitored by an automated video system.

As can be seen from the above-described example of the invented technique, the technique provides a multi-rout calculation method for automated determination of calibration parameters. A validation check can be performed on the calculated parameters; and prior assumption (which might be required for the calculation) can vary if some parameters are found as not valid.

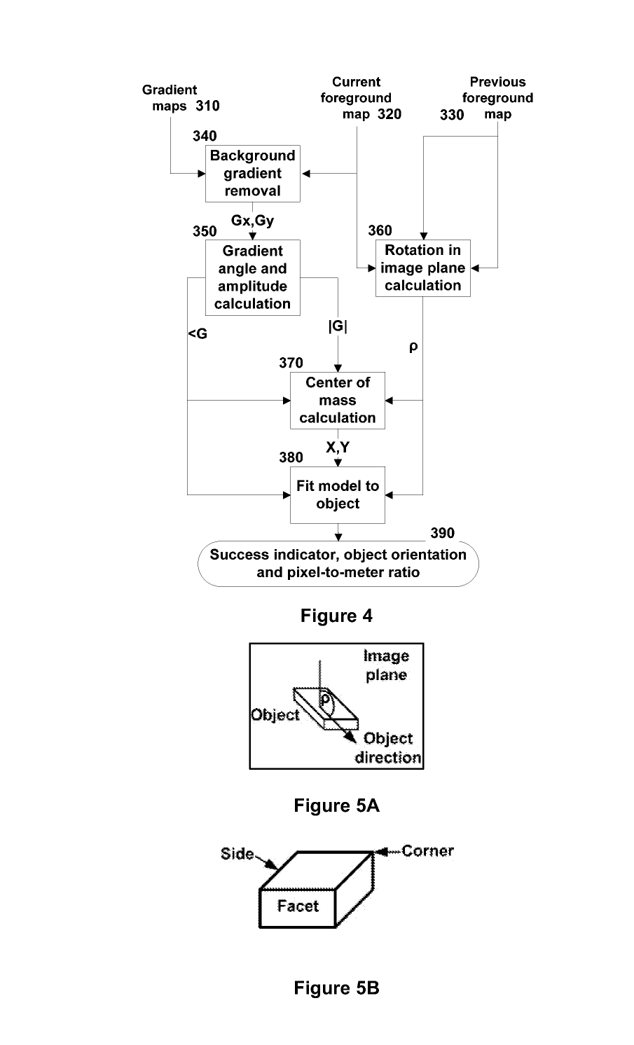

Reference is made to FIG. 4 showing a flow-chart exemplifying a 3D model fitting procedure suitable to be used in the invention. The procedure utilizes data input in the form of gradient maps 310 of the captured images, current- and previous-frame foreground binary maps 320 and 330. The input data is processed by sub-modules of the processing module 160A running the following algorithms: background gradient removal (step 340), gradient angle and amplitude calculation (step 350), calculation of a rotation angle of the blobs in the image plane (step 360), calculation of a center of mass (step 370), model fitting (step 380), and data validation and calculation of the calibration parameters (step 390).

As indicated above, the processor utilizes foreground binary image of the i-th frame 330 and of the (i+1)-th frame 320, and also utilizes a gradient map 310 of at least one of the previous and current frames. The processor operates to extract the background gradient from the gradient map 310. This may be implemented by comparing the gradient to the corresponding foreground binary image (in this non-limiting example binary image of the (i+1)-th frame 320 (step 340). This procedure consists of removing the gradients that belong to the background of the image. This is aimed at eliminating non-relevant features which could affect the 3D model fitting process. The background gradient removal may be implemented by multiplying the gradient map (which is a vector map and includes the vertical gradients G_{y} and horizontal gradients Gₓ) by the foreground binary map. This nulls all background pixels while preserving the value of foreground pixels.

The gradient map, containing only the foreground gradients, is then processed via the gradient angle and amplitude calculation algorithm (step 350), by transforming the gradient map from the Cartesian representation into a polar representation composed of the gradient amplitude and angle. A map containing the absolute value of the gradients and also another map holding the gradients' orientation are calculated. This calculation can be done using equations 2 and 3.

$$\begin{matrix}\vert G \vert = \sqrt{{G}_{x}^{2} + {G}_{y}^{2}} & ( eqn . 2 ) \\ \leq G = {tan}^{- 1} ( {G}_{y} / {G}_{x} ) & ( eqn . 3 )\end{matrix}$$

In order to ensure uniqueness of the result, the angle is preferably set to be between 0 to 180 degrees.

Concurrently, a rotation angle of the blobs in the image plane is determined (step 360). This can be implemented by calculating a direction of propagation for objects/blobs (identified as foreground in the image stream) as a vector in Cartesian representation and provides a rotation angle, i.e. polar representation, of the object in the image plane. It should be noted that, as a result of the foreground/background segmentation process, almost only moving objects are identified and serve as blobs in the image.

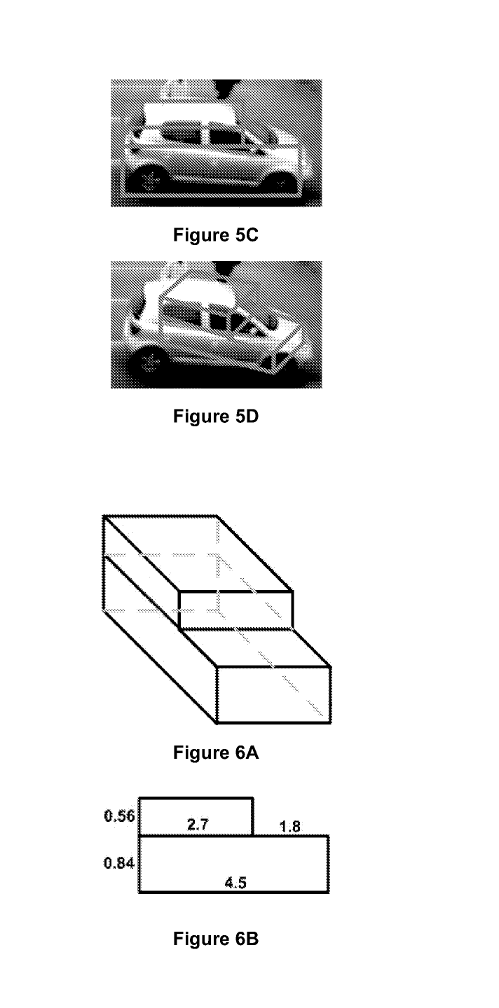

FIG. 5A illustrates the rotation angle ρ of an object/blob within the image plane. The calculated rotation angle may then be translated into the object's true rotation angle (i.e., in the object plane) which can be used, as will be described below, for calculation of the object's orientation in the “real world” (i.e., in the region of interest).

For example, the rotation angle calculation operation includes calculation of the center of the blob as it appears in the foreground image (digital map). This calculation utilizes equation 4 and is applied to both the blobs in the current frame (frame i+1) and the corresponding blobs in the previous frame (i).

$${X}_{c , i} = \frac{( {X}_{2 , i} + {X}_{1 , i} )}{2} ; {Y}_{c , i} = \frac{( {Y}_{1 , i} + {Y}_{2 , i} )}{2} \qquad ( eqn . 4 )$$

Here X_{c,i,} is the x center coordinate for frame i, and X_{1,i} and X_{2,i} are the x coordinates of two corners of the blob's bounding box, this also applies for y coordinates.

It should be noted that the determination of the rotation angle may also utilize calculation of a center of mass of the blob, although this calculation might in some cases be more complex.

To find the velocity vector of the object (blob), a differences between the centers of the blob in both x- and y-axes between the frame i and frame (i+1) is determined as:

dX=X_{c,1}−X_{c,0}

dY=Y_{c,1}−Y_{c,0} (eqn. 5)

Here dX and dY are the object's horizontal and vertical velocities respectively, in pixel units, X_{c,1} and Y_{c,1} are the center coordinates of the object in the current frame and X_{c,0} and Y_{c,0} are the center coordinates of the object in the previous frame.

The rotation angle ρ can be calculated using equation 6 as follows:

$$ρ = arctan ( \frac{d Y}{d X} ) \qquad ( eqn . 6 )$$

The center of mass calculation (step 370) consists of calculation of a location of the center of mass of a blob within the frame. This is done in order to initiate the model fitting process. To this end, the gradient's absolute value map after background removal is utilized. Each pixel in the object's bounding box is given a set of coordinates with the zero coordinate being assigned to the central pixel. The following Table 1 corresponds to a 5×5 object example.

TABLE 1

| | | | | |
|---|---|---|---|---|
| −2, −2 | −1, −2 | 0, −2 | 1, −2 | 2, −2 |
| −2, −1 | −1, −1 | 0, −1 | 1, −1 | 2, −1 |
| −2, 0 | −1, 0 | 0, 0 | 1, 0 | 2, 0 |
| −2, 1 | −1, 1 | 0, 1 | 1, 1 | 2, 1 |
| −2, 2 | −1, 2 | 0, 2 | 1, 2 | 2, 2 |

A binary gradient map is generated by applying a threshold on the gradient absolute values map such that values of gradients below a predetermined threshold are replaced by binary “0”; and gradient values which are above the threshold are replaced with binary “1”. The calculation of the center of mass can be done using a known technique expressed by equation 7.

$${X}_{c m} = \frac{{\sum }_{i} {\sum }_{j} {G}_{i , j} i}{{\sum }_{i} {\sum }_{j} {G}_{i , j}} ; \\ {Y}_{c m} = \frac{{\sum }_{i} {\sum }_{j} {G}_{i , j} i}{{\sum }_{i} {\sum }_{j} {G}_{i , j}} \qquad ( eqn . 7 )$$

Here X_{cm} and Y_{cm} represent the coordinates as described above in table 1, G_{i,j} is the binary gradient image value in coordinates (i,j), and i and j are the pixel coordinates as defined above. The coordinates of the object (blob) may be transformed to the coordinates system of the entire image by adding the top-left coordinates of the object and subtracting half of the object size in pixel coordinates; this is in order to move the zero from the object center to the frame's top-left corner.

The model fitting procedure (step 380) consists of fitting a selected 3D model (which may be stored in the memory utility of the device) to the selected blobs. The device may store a group of 3D models and select one or more models for fitting according to different pre-defined parameters. Thus, during the model fitting procedure, a 3D model, representing a schematic shape of the object, is applied to (projected onto) an object's image, i.e. object's representation in the 2D image plane. Table 2 below exemplifies a pseudo-code which may be used for the fitting process.

TABLE 2

For α=α1:α2

For ρ=ρ−ε:ρ+ε

Calculate rotation angle in object plane;
Calculate model corners;
Calculate pixel to meter ratio (R);
For R=R:RM

Calculate object dimension in pixels;
Recalculate model corners;
Calculate model sides;
Check model validity;
If model is valid

Calculate model score;
Find maximum score;

End

End

End

End

Here α1 and α2 represent a range of possible angles according of the camera orientation. This range may be the entire possible 0 to 90 degrees range of angle, or a smaller range of angles determined by a criteria on the camera orientation, i.e. angled mounted camera or overhead camera (in this non limiting example, the range is from 4 to 40 degrees for angled cameras and from 70 to 90 degrees for overhead cameras). In the table, α is an assumed angle of the camera orientation used for the fitting process and varies between the α1 and α2 boundaries; ρ is the object's rotation angle in the image plane which was calculated before; ε is a tolerance measure; and M is a multiplication factor for the PMR R.

The model fitting procedure may be performed according to the stages presented in table 2 as follows:

For a given camera angle α, according to the calculation process, and the determined image plane rotation ρ of the object, an object plane angle θ is calculated.

$$θ = {tan}^{- 1} ( \frac{tan ρ}{sin α} ) \qquad ( eqn . 8 )$$

Equation (8) shows calculation of the object angle as assumed to be in the region of interest (real world). This angle is being calculated for any value of α used during the model fitting procedure. This calculation is also done for several shifts around the image plane rotation angle ρ; these shifts are presented in table 2 by a value of ε which is used to compensate for possible errors in calculation of ρ.

Then, position and orientation of the corners of the 3D model are determined. The model can be “placed” in a 3D space according to the previously determined and assumed parameters α, θ, the object's center of mass and the model's dimensions in meters (e.g. as stored in the devices memory utility). The 3D model is projected onto the 2D image plane using meter units.

Using the dimensions of the projected model in meters, and of the foreground blob representing the object in pixels, the PMR can be calculated according to the following equation 9.

$$R = \frac{{Y}_{p , max} - {Y}_{p , min}}{{Y}_{m , max} - {Y}_{m , min}} \qquad ( eqn . 9 )$$

In this equation, R is the PMR, Y_{p,max} and Y_{p,min} are the foreground blob bottom and top Y pixel coordinates respectively, and Y_{m,max} and Y_{m,min} are the projected model's lowest and highest points in meters respectively.

The PMR may be calculated by comparing any other two points of the projected model to corresponding points of the object; it may be calculated using the horizontal most distant points, or other set of points, or a combination of several sets of distant relevant points. The PMR R is assumed to be correct, but in order to provide better flexibility of the technique of the invention, a variation up to multiplication factor M is allowed for fitting the 3D model.

Using the PMR, the dimensions of the model in pixels can be determined. This can be done by transforming the height, length and width of the 3D model from meters to pixels according to equation 10.

Hₚ=HₘR

Wₚ=WₘR

Lₚ=LₘR (eqn. 10)

where H is the model height, W its width, L its length and R is the PMR, and the subscripts p and m indicate a measure in pixels or in meters, respectively.

In some embodiments, the 3D model fitting is applied to an object which has more resemblance to human, i.e. pedestrian. In such embodiments, and in other embodiments where a model is being fit to a non-rigid object, the model has smaller amount of details and therefore simple assumptions on its dimensions might not be sufficient for the effective determination of PMR. As will be described further below, the proper model fitting and data interpretation are used for “rigid” and “non-rigid” objects.

The location of the corners of the projected model can now be re-calculated, as described above, using model dimensions in pixels according to the calculated ratio R. Using the corners' location data and the center of mass location calculated before, the sides of the projected model can be determined. The terms “corners” and “sides” of a 3D model projection are presented in self-explanatory manner in FIG. 5B.

The model fitting procedure may also include calculation of the angle of each side of the projected model, in a range of 0-180 degrees. The sides and points which are hidden from sight by the facets of the model, according to the orientation and point of view direction, may be ignored from further considerations. In some model types, inner sides of the model may also be ignored even though they are not occluded by the facets. This means that only the most outer sides of the model projection are visible and thus taken into account. For example, in humans the most visible contours are their most outer contours.

A validity check on the model fitting process is preferably carried out. The validity check is based on verifying that all of the sides and corners of the model projection are within the frame. If the model is found to extend outside the frame limits, the processor utility continues the model fitting process using different values of α, ρ and R. If the model is found valid, a fitting score may be calculated to determine a corresponding camera angle α and best PMR value for the image stream. The score is calculated according to the overlap of the model orientation in space as projected on the image plane and the contour and edges of the object according to the gradient map. The fitting score may be calculated according to a relation between the angles of each side of the model and the angles of the gradient map of each pixel of the object. FIGS. 5C and 5D exemplify a good-fit of a car model to a car's image (FIG. 5C) and a poor fit of the same model to the same car image (FIG. 5D).

The model fitting procedure may be implemented as follows: A selected model is projected onto the object representation in an image. The contour of the model is scanned pixel-by-pixel, a spatial angle is determined, and a relation between the spatial angle and the corresponding image gradient is determined (e.g. a difference between them). If this relation satisfies a predetermined condition (e.g. the difference is lower than a certain threshold), the respective pixel is classified as “good”. A number of such “good” pixels is calculated. If the relation does not satisfy the predetermined condition for a certain pixel, a certain “penalty” might be given. The results of the filtering (the number of selected pixels) are normalized for a number of pixels in the model, “goodness of fit” is determined. The procedure is repeated for different values of an assumed angle of the camera orientation, of the object's rotation angle in the image plane and of the PMR value, and a maximal score is determined. This value is compared to a predetermined threshold to filter out too low scores. It should be noted that the filtering conditions (threshold values) are different for “rigid” and non-rigid” objects (e.g. cars and humans). This will be described more specifically further below.

It should be noted that the fitting score for different model types may be calculated in different ways. A person skilled in the art would appreciate that the fitting process of a car model may receive a much higher score than a walking man model, as well as animal or any other non-rigid object related models. Upon finding the highest scored camera orientation (for a given camera orientation mode, i.e. angles or overhead) and PMR, the procedure is considered successful to allow for utilizing these parameters for further calculations. It should however be noted, that the PMR might vary in different zones of the image of the region of interest. It is preferred therefore to apply model fitting to several objects located in different zones of the frame (image).

The present invention may utilize a set of the calculated parameters relating to different zones of the frame. For example, and as indicated above, the PMR may vary in different zones of the frame and a set of PMR values for different zones can thus be used. The number of zones in which the PMR is calculated may in turn vary according to the calculated orientation of the camera. For angled camera orientations, i.e. angles lower than about 40, in some embodiments lower than 60 or 70, degrees, calculation of PMR in 8 horizontal zones can be utilized. In some embodiments, according to the pixel to meter calculated ratio, the number of zones may be increased to 10, 15 or more. In some other embodiments, the PMR may be calculated for any group of pixels containing any number of pixels. For overhead orientation of the camera, i.e. angles of 70 to 90 degrees, the frame is preferably segmented into about 9 to 16 squares, in some embodiments the frame may be segmented into higher number of squares. The exact number of zones may vary according to the PMR value and the changes of the value between the zones. In the overhead camera orientations, the PMR may differ both along the horizontal axis and along the vertical axis of the frame.

Preferably, as described above, the system utilizes calculation of PMR values for several different zones of the frame to determine the camera orientation mode to be used. After calculating the PMR for several different zones of the frame, the data processing may proceed for calculation of PMR for other zones of the frame by linear regression procedure. It should be noted that in angled camera orientation mode of the camera, the PMR values for different zones are expected to vary according to a linear model/function, while in the overhead camera orientation mode PMR values typically do not exhibit linear variation. Determination of the optimal camera orientation mode may be based on success of linear regression process, wherein upon a success in calculation of the PMR using linear regression the processor determines the orientation mode as angled. This is while failure in calculation of PMR using linear regression, i.e. the calculated PMR does not display linear behavior, results in decision to use the overhead orientation mode of the camera. As described above, such linear regression can be applied if the PMR is calculated for a sufficient number of zones, and preferably calculated according to a number of objects higher than a predetermined threshold. It should be noted that if linear regression is successful, but in some zones the PMR calculated is found to be negative, the respective value may be assumed to be the positive value of the closest zone. If the linear regression is not successful and overhead orientation is selected, the PMR for zones in which it is not calculated is determined to be the average value of the two (or four) neighboring zones.

As exemplified above, the technique of the invention may utilize projection of a predetermined 3D model onto the 2D representation of the object in an image. This 3D model projection is utilized for calculating the PMR and the orientation of the camera. However, techniques other then 3D model projection can be used for determining the PMR and camera orientation parameters, such as calculation of average speed of objects, location and movement of shadows in the scene and calculation of the “vanishing point” of an urban scene.

In case the 3D model projection is used, the invention provides for calibrating different video cameras in different environments. To this end, a set of pre-calculated models is preferably provided (e.g. stored or loaded into the memory utility of the device). The different types of such model may include a 3D model for projection on a car image and on an image of a human. However, it should be noted that other types of model may be used, and may be preferred for different applications of the calibration technique of the invention. Such models may include models of dogs, or other animals, airplanes, trucks, motorcycles or any other shape of objects.

A typical 3D car model is in the form of two boxes describing the basic outline of a standard car. Other models may be used, such as a single box or a three boxes model. The dimensions of the model can be set manually, with respect to average car dimensions, for most cars moving in a region in which the device is to be installed, or according to a predefined standard. Typical dimensions may be set to fit a Mazda-3 sedan, i.e. height of 1.4 meters, length of 4.5 meters and width of 1.7 meters.

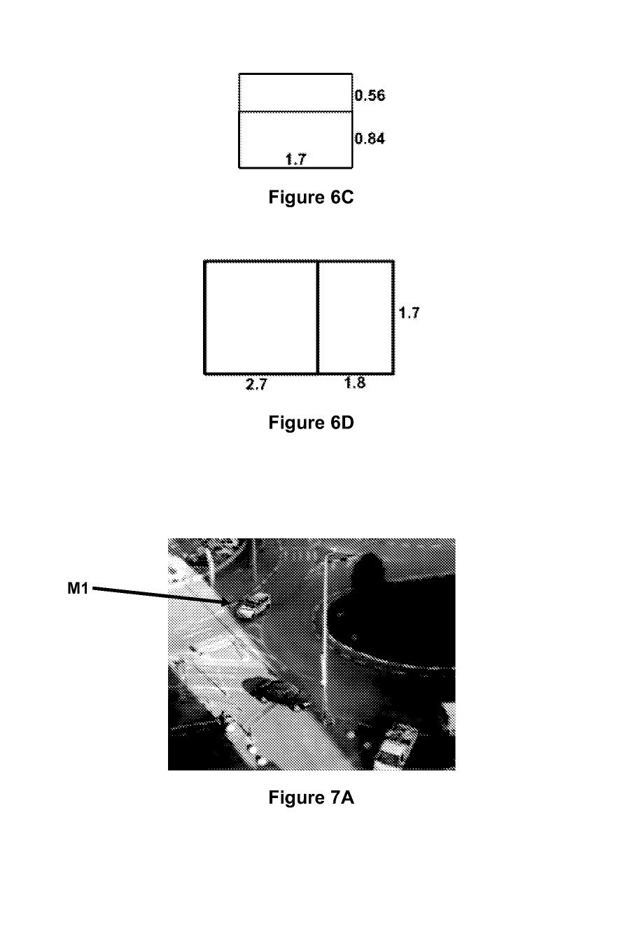

Reference is made to FIGS. 6A to 6D showing an example of a two-box 3D car model which may be used according to the invention. FIG. 6A shows the model from an angled orientation illustrating the three dimensions of the model. FIGS. 6B to 6D show side, front or back, and top views of the model respectively. These figures also show relevant dimensions and sizes in meters of the different segments of the model. As can be seen in the figures, some segments of the model can be hidden from view by the facets. As mentioned above, these hidden segments may be removed during the model fitting process and not used for calculation of the calibration parameters or for the model fitting.

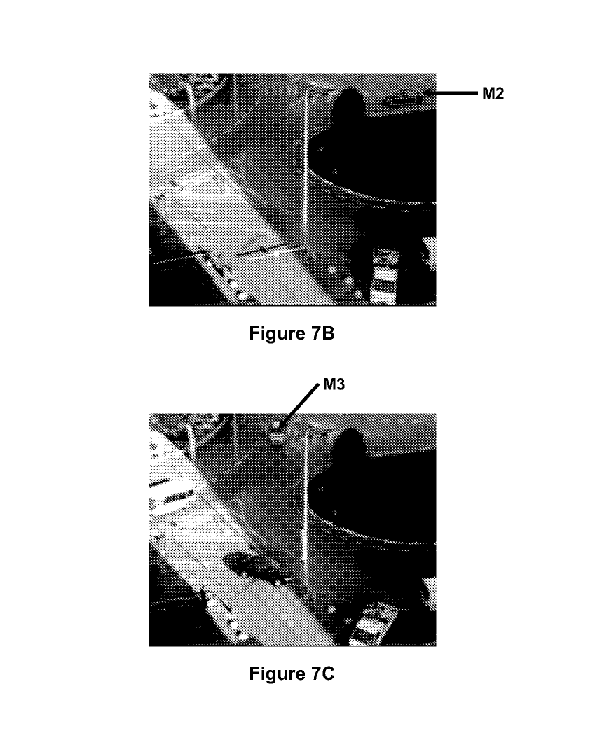

Three examples of car models fitting to an image are shown in FIGS. 7A to 7C. All these figures show a region of interest, in which cars are moving. The 3D models (M1, M2 and M3) fitted to a car in the figures respectively are shown as a box around the car.

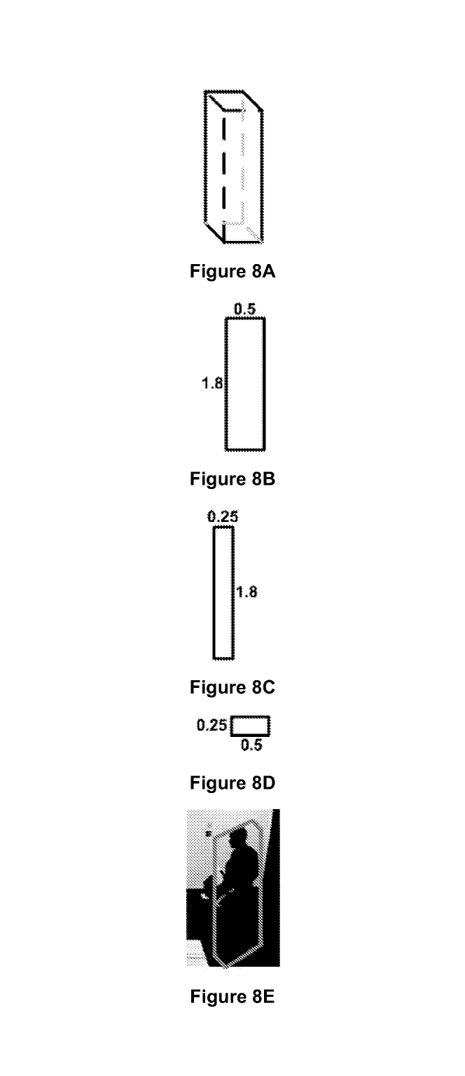

Models of humans are a bit more limited; since humans are not “rigid” objects such as cars, the model is only valid in scenarios in which the pedestrians are far enough from the camera and are viewed from a relatively small angle. Reference is made to FIGS. 8A to 8E showing a 3D pedestrian model from different points of view. The model is a crude box that approximates a human to a long and narrow box with dimensions of about 1.8×0.5×0.25 meters. FIG. 8A shows the model from an angled orientation, again illustrating the three dimensions of the model, while FIGS. 8B to 8D show the pedestrian model from the back or front, side and a top view of the model respectively.

Since the model for fitting to a pedestrian is a very crude approximation, most people do not exhibit straight gradients, especially not in the center of the body, and only in some cases such gradients outline the peripherals. For fitting of a pedestrian model, only lines considered visible are kept. These lines are the most outer sides of the box, while hidden lines, together with inner lines which are typically visible, are deleted. FIG. 8E shows a man and the corresponding model. As can be seen in the figure, only the outer lines are kept and utilized in the calculation of score for the fitting of the model. These lines are shown in FIG. 8A as solid lines, while all inner and hidden lines are shown dashed lines.

As indicated above, calculation of the PMR in some embodiments require a more sensitive technique. Such embodiments are those utilizing fitting a model to a non-rigid object like a pedestrian. A more sensitive technique is usually required in overhead orientations of the camera (i.e. angle α of about 70-90 degrees).

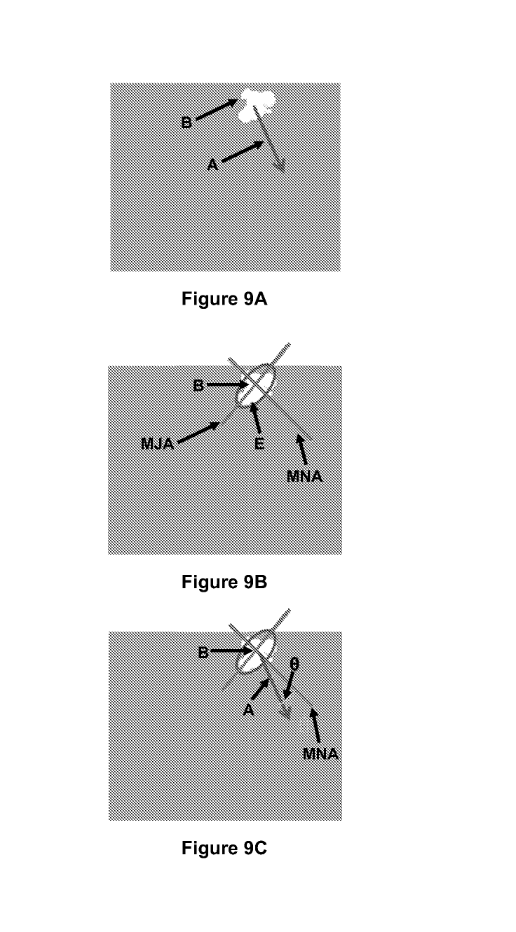

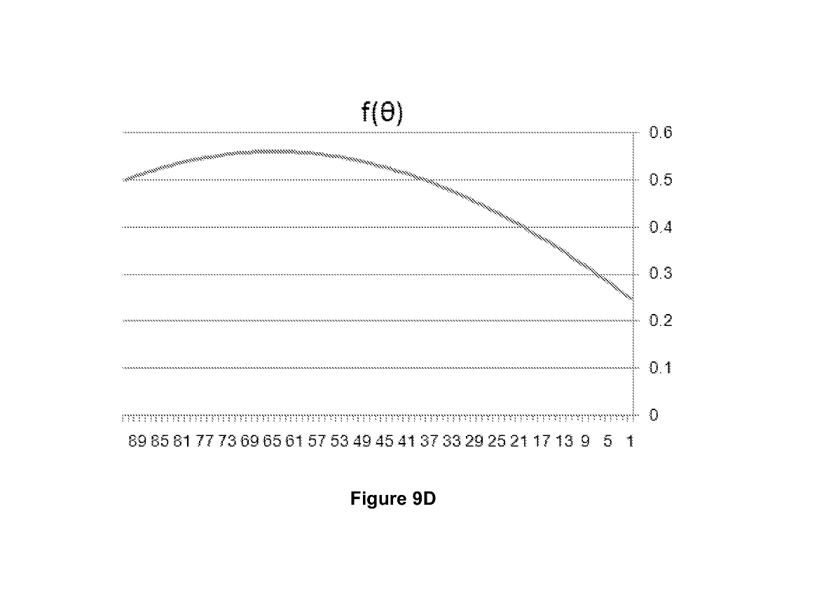

Reference is made to FIGS. 9A to 9D showing an overhead map and an example of PMR calculation for a pedestrian in the scene. In FIG. 9A, a blob B representing a pedestrian is shown from an overhead orientation together with its calculated velocity vector A. In FIG. 9B, the blob is approximated by an ellipse E and the major MJA and minor MNA axes of this ellipse are calculated. The axes calculation may be done using Principal component analysis (PCA).

An angle θ, between the minor axis MNA and the velocity vector A is identified, as seen in FIG. 9C. A heuristic function correlating the angle θ and a portion between a width and a depth of a person's shoulder (the distance between the two shoulders and between the chest and back) and the length of the minor axis of the ellipse can be calculated using equation 11.

Y=f(θ)=W sin θ+D cos θ (eqn. 11)

where Y is the length of the minor axis in meters, W is the shoulder width in meters (assumed to be 0.5 for a pedestrian), D is the shoulder depth in meters (assumed to be 0.25) and θ is the angle between the minor axis and the velocity vector.

FIG. 9D shows a graph plotting the equation 11; the x-axis of the graph is the angle θ in degrees and the y-axis represents the length Y of the minor axis of the ellipse A. When the angle θ is relatively small, the minor axis contains mostly the shoulder depth (0.25), while as the angle gets larger the portion of the shoulder width gets larger as well.

Calculation of the length of the minor axis in pixels, according to the identified blob, can be done using the PCA. The smallest Eigen-value A of the PCA is calculated and the length of the minor axis y in pixels is given by:

y=(λ/12)^{1/2} (eqn. 12)

The PMR R can now be calculated by dividing the minor axis length in pixels y by the calculated length in meters Y.

This technique or modification thereof may be used for PMR calculation for any type of non-rigid objects which have ellipsoid characteristics (i.e. having ellipsoid body center). Such types of non-rigid objects may be animals like dogs or wild animals whose behavior may be monitored using a system calibrated by a device of the present invention.

Turning back to FIG. 2, the processor utility 104 may also be configured and operable to determine the scene-related calibration parameters using sub-module 160B. The scene-related parameter may be indicative of the type of illumination of the region of interest. The type of illumination can be a useful parameter for applying sophisticated recognition algorithms at the server's side. There are many more parameters relating to operation of a video content analysis system which depend on the characteristics of the scene lighting. One of the main concerns related to the illumination is the temporal behavior of the scene lighting, i.e. whether the illumination is fixed in time or changes. The present invention utilizes a classifier to differentiate artificial lighting (which is fixed in most embodiments) from natural lighting (which varies along the hours of the day).

Scene illumination type can be determined according to various criteria. In some embodiments, spectral analysis of light received from the region of interest can be performed in order to differentiate between artificial lighting and natural lighting. The spectral analysis is based on the fact that solar light (natural lighting) includes all visible frequencies almost equally (uniform spectrum), while most widely used artificial light sources produce non-uniform spectrum, which is also relatively narrow and usually discrete. Furthermore, most artificial streetlights have most of their energy concentrated in the long waves, i.e. red, yellow and green rather than in the shorter wavelength like blue.

Other techniques for determining type of illumination may focus on a colored histogram of an image, such as RGB histogram in visible light imaging.

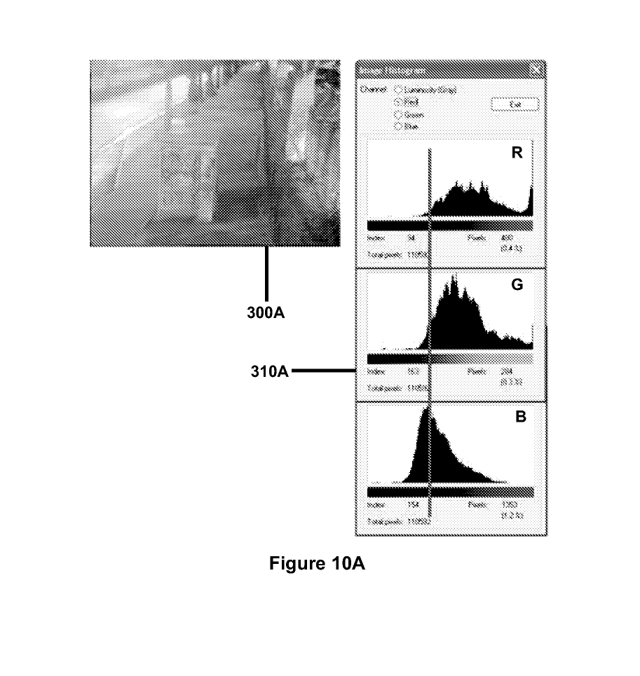

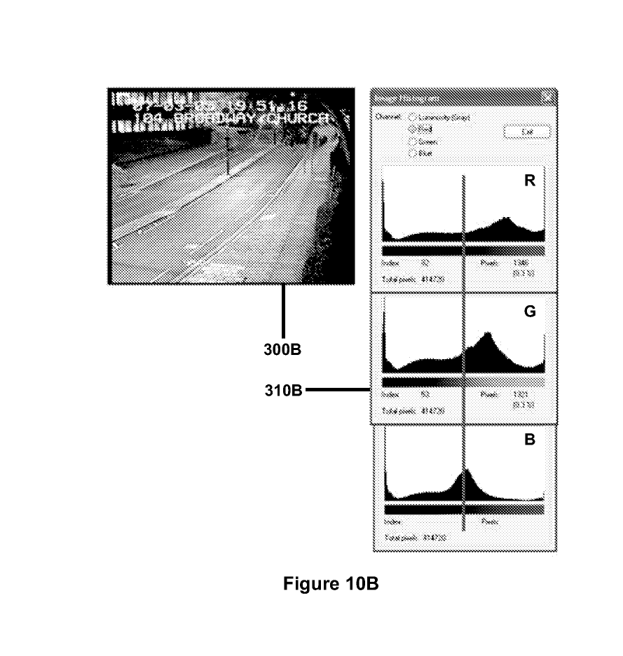

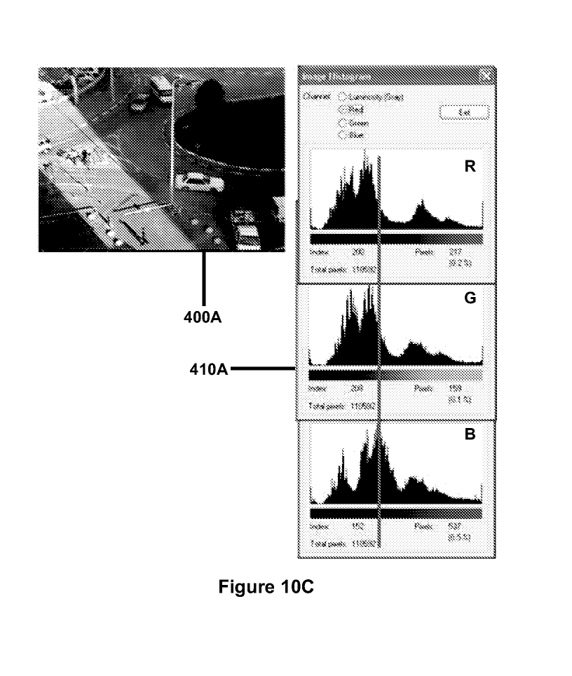

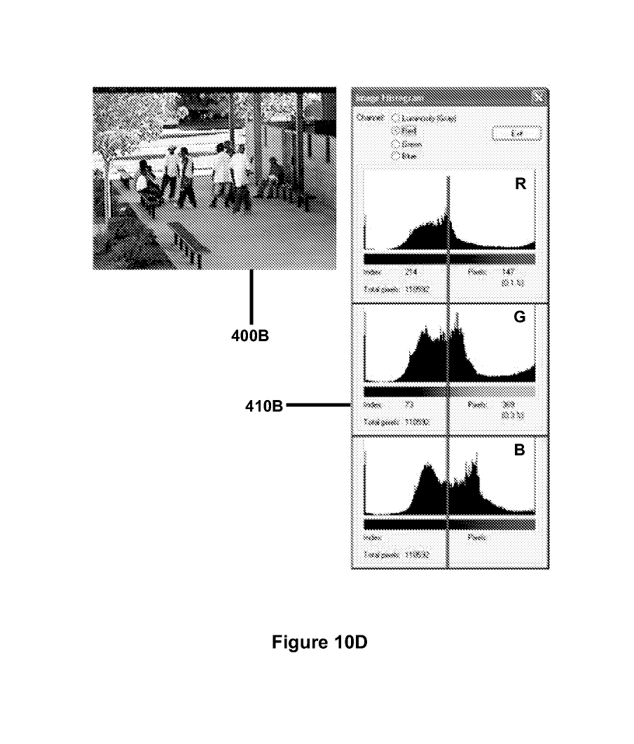

Reference is now made to FIGS. 10A to 10D showing four images and their corresponding RGB histograms. The inventors have found that in daytime scenarios (natural lighting) the median of the histogram is relatively similar for all color components, while in artificial lighting scenarios (usually applied at night vision or indoors) the median of the blue component is significantly lower than the medians of the other two components (red and green).

FIGS. 10A and 10B show two scenes at night, illuminated with artificial lighting, and FIGS. 10C and 10D show two scenes during daytime, illuminated by the Sun. The RGB histograms corresponding to each of these images are also shown, a vertical line corresponds to the median of the blue histogram. In FIGS. 10A and 10B the median of the blue histogram is lower than the median of the green and red histograms. This is while in FIGS. 10C and 10D the medians of the blue, green and red histograms are at substantially the same value. It can therefore be seen that in the night scenes (artificial lighting) there is less intensity (energy) in short wavelengths (blue) relative to longer wavelengths (green and red), and in the daytime scenes (natural lighting) the intensity is spread evenly between all three color components of the image.

Based on the above findings, the technique of the invention can determine whether the lighting in a scene is artificial or not utilizing colored histogram of the image. For example, after the calculation of the histograms (by module 150 in FIG. 2), the medians for the red and blue histograms are calculated. The two medians are compared to one another, and if the ratio is found to be larger than a predetermined threshold the scene is considered as being illuminated by artificial light, if the ratio is smaller than the threshold, the scene is considered to be illuminated with natural light. Other parameters, statistical or not, may be used for comparison to identify whether the scene is under artificial or natural illumination. These parameters may include the weighted average RGB value of pixels. It should also be noted that other parameters may be used for non visible light imaging, such as IR imaging.

The present invention also provides a technique for automatically identifying the object type represented by a blob in an image stream. For example, the invention utilizes a histogram of gradients for determining whether a blob in an overhead image represents a car, or other types of manmade objects, or a human. It should be noted that such object type identification technique is not limited to differentiating between cars and humans, but can be used to differentiate between many manmade objects and natural objects.

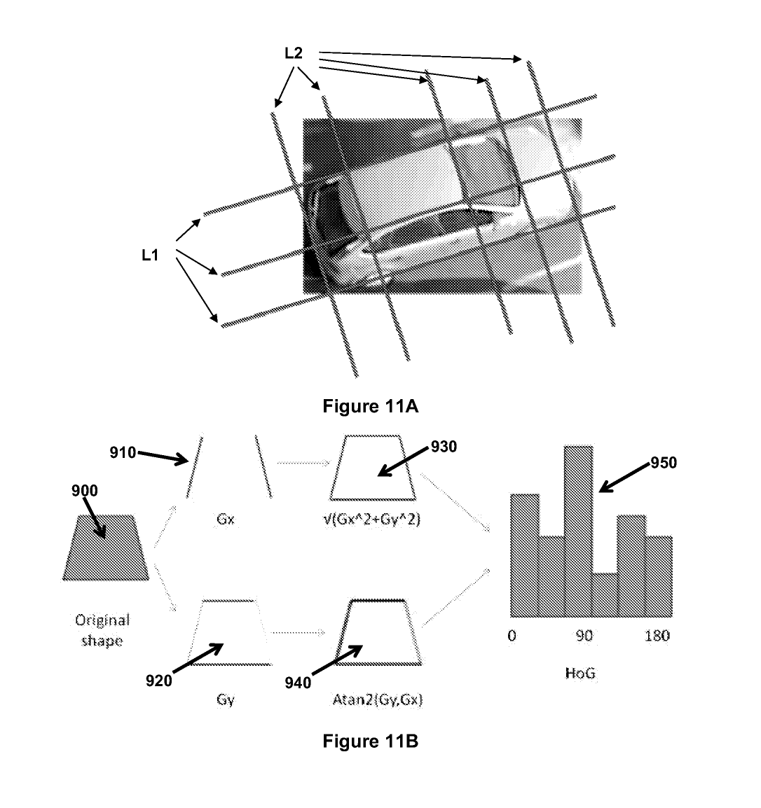

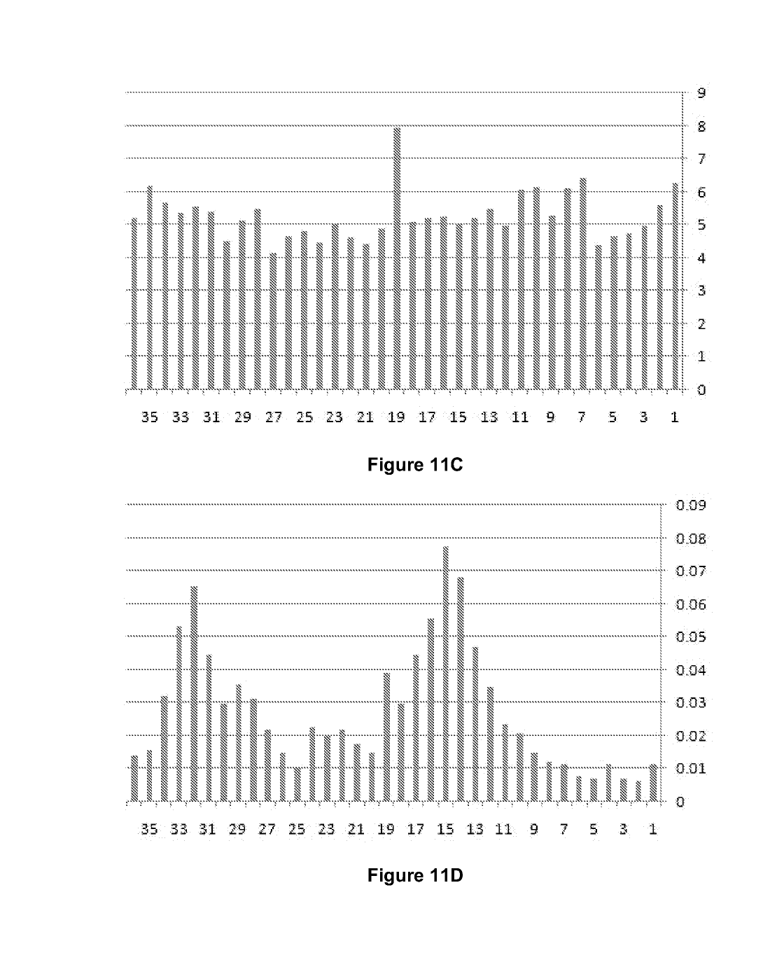

Reference is now made to FIGS. 11A to 11D exemplifying how the technique of the present invention can be used for differentiating between different types of objects. FIG. 11A shows an overhead view of a car and illustrates the two main axes of the contour lines of a car. FIG. 11B exemplifies the principles of calculation of a histogram of gradients. FIGS. 11C and 11D show the histograms of gradients for a human and car respectively.

The inventors have found that, especially from an overhead point of view, most cars have two distinct axes of the contour lines. These contour lines extend along the car's main axis, i.e. along the car's length, and perpendicular thereto, i.e. along the car's width. These two main axes of the contour lines of a car are denoted L1 and L2 in FIG. 11A. On the other hand, pedestrian or any other non-rigid object, has no well defined distinct gradients directions. This diversity is both internal and external, e.g. within a certain person lies a high variance in gradient direction, as well as there is a high variance in gradient directions between different persons in the scene.

As shown in FIG. 11B, the gradients of an input blob 900, which is to be identified, can be determined for all of the blob's pixels. The gradients are calculated along both x and y axes (910 and 920 respectively). In some embodiments, where a scene includes many blobs with similar features, the blobs may be summed and the identification technique may be applied to the average blob to reduce the noise sensitivity. Such averaging may be used in scenes which are assumed to include only one type of objects.

The absolute value of the gradient is calculated for each pixel 930 and analyzed: if the value is found to be below a predetermined threshold it is considered to be “0” and if the value is above the threshold it is considered to be “1”. Additionally, the angle of the gradient for each pixel may be determined using an arctangent function 940, to provide an angle between 0 and 180 degrees.

As further shown in FIG. 11B, the histogram of gradients 950 is a histogram showing the number of pixels in which the absolute value of the gradient is above the threshold for every angle of the gradient. The x-axis of the histogram represents the angle of the gradient, and the y-axis represents the number of pixels in which the value of the gradient is above the threshold. In order to ensure the validity and to standardize the technique, the histograms may be normalized.

FIGS. 11C and 11D show gradient histograms of blobs representing a human (FIG. 11C) and a car (FIG. 11D), each bin in these histograms being 5 degrees wide. As shown, the gradient histogram of a human is substantially uniform, while the gradient histogram of a car shows two local maxima at about 90 degrees angular space from one another. These two local maxima correspond to the two main axes of the contour lines of a car.

To differentiate between a car and a human, the maximal bin of the histogram together with is closest neighboring bins are removed. A variance of the remaining bin can now be calculated. In case the object is a human, the remaining histogram is substantially uniform, and the variance is typically high. In cases the object is a car, the remaining histogram is still concentrated around a defined value and its variance is lower. If the variance is found to be higher than a predetermined threshold, the object is considered a human (or other natural object), and if the variance is found to be lower than the threshold, the objects is considered to be a car (or other manmade object).

In addition, the invention also provides for differentiating cars and people according to the difference between their orientation, as captured by the sensor, and their velocity vector. In this method, each object is fitted an ellipse, as depicted in FIG. 9B, and the angle between its minor axis and its velocity vector is calculated, as depicted in FIG. 9C. These angles are recorded (stored in memory) and their mean μ and standard deviation σ are calculated over time.

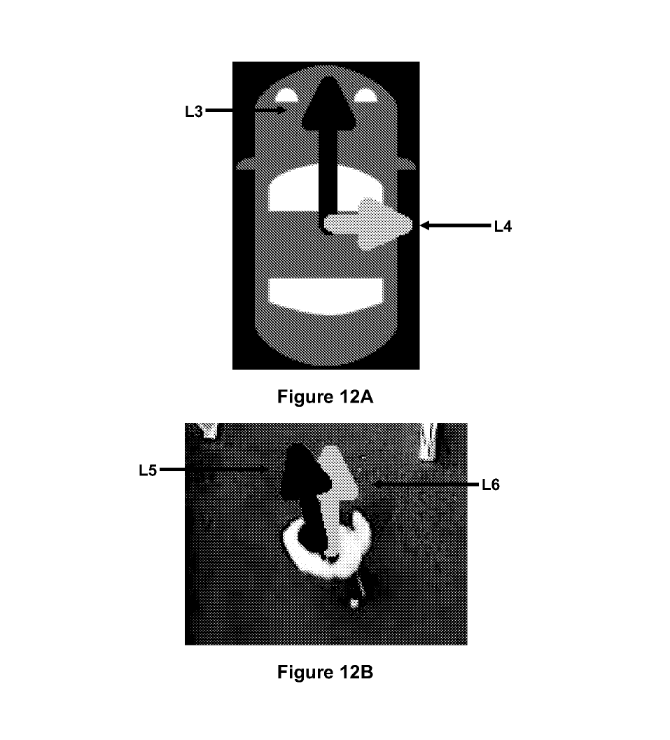

Since cars are lengthy, i.e. theirs width is usually much smaller than theirs length, from an overhead view there is a significant difference between their blob orientation and their velocity vector. This can be seen clearly in FIG. 12A where the velocity vector and the car's minor axis denoted as L3 and L4 respectively. In contrast, as seen in FIG. 12B, most people from an overhead view move in parallel to their minor axis. Here, L5 and L6 are the person's velocity vector and minor axis, respectively.

To differentiate between a scene in which most of the objects are cars and a scene in which people are the dominant moving object, the difference (μ−σ) is compared to a predefined threshold. If this difference is higher than the threshold, then the scene is dominated by cars, either wise by people.

Both people/cars classification methods can operate alone or in a combine scheme. Such scheme can be a weighted vote, in which each method is assigned a certain weight and their decisions are integrated according to these weights.

In order to ensure the validity of the calculated parameters, a validity check may be performed. Preferably, the validity check is performed for both the validity of the calculated parameters and the running time of the calculation process. According to some embodiments, the verification takes into account the relative amount of data in order to produce reliable calibration. For example, if the PMR value has been calculated for a 3 zones out of 8 zones of the frame, the calculation may be considered valid. In some embodiments, calculation is considered valid if the PMR has been calculated for 40% of the zones, or in some other embodiments, calculation for at least 50% or 60% of the zones might be required.

Calculation of each parameter might be required based on more than a single object for each zone, or even for the entire frame. The calculated parameters may be considered valid if it has been calculated for a single object, but in some embodiments calculation of the calibration parameters is to be done for more than one object.

If at least some of the calculated parameters are found invalid, the device operates to check whether the maximum running time has passed. If the maximal time allowed for calibration, the calculated parameters are used as valid ones. If there still remains allowed time for calibration, according to a predetermined calibration time limit, the device attempts to enhance the validity of the calculated parameters. In some embodiments, if there is no more allowed time the calculated parameters are considered less reliable, but still can be used.

In some embodiments, if a valid set of the calibration parameters cannot be calculated during a predetermined time limit for calibration, the device reports a failure of automatic calibration procedure. A result of such report may be an indication that manual calibration is to be performed. Alternatively, the device may be configured to execute another attempt for calibration after a predetermined amount of time in order to allow fully automatic calibration.

Thus, the present invention provides a simple and precise technique for automatic calibration of a surveillance system. An automatic calibration device of the invention typically focuses on parameters relating to the image stream of video camera(s) connected to a video surveillance system. The auto-calibration procedure utilizes several images collected by one or more cameras from the viewed scene(s) in a region of interest, and determines camera-related parameters and/or scene-related parameters which can then be used for the event detection. The auto-calibration technique of the present invention does not require any trained operator for providing the scene- and/or camera-related input to the calibration device. Although the automatic calibration procedure may take some time to calculate the above described parameters, it can be done in parallel for several cameras and therefore actually reduce the calibration time needed. It should be noted that although manual calibration usually takes only about 10-15 minutes it has to be done for each camera separately and might therefore require large volume of work. Moreover, auto-calibration of several cameras can be done simultaneously, while with the manual procedure an operator cannot perform calibration of more than one camera at a time. In the manual setup and calibration process, an operator defines various parameters, relating to any specific camera, and enters them into the system. Entry of these parameters by the operator provides a “fine tune” of details relevant to the particular environment viewed by the specific camera. These environment-related details play a role in the video stream analysis which is to be automatically performed by the system, and therefore affect the performance of the event detection system.

1. A calibration device for use in a surveillance system for event detection, the calibration device comprising an input utility for receiving data indicative of an image stream of a scene in a region of interest acquired by at least one imager and generating image data indicative thereof, and a data processor utility configured and operable for processing and analyzing said image data, and determining at least one calibration parameter including at least one of the imager related parameter and the scene related parameter.

2. The device of claim 1, wherein said at least one imager related parameter comprises at least one of the following:
a ratio between a pixel size in an acquired image and a unit dimension of the region of interest;
orientation of a field of view of said at least one imager in relation to at least one predefined plane within the region of interest being imaged.

3. The device of claim 1, wherein said at least one scene related parameter includes illumination type of the region of interest while being imaged.

4. The device of claim 3, wherein said data indicative of the illumination type comprises information whether said region of interest is exposed to either natural illumination or artificial illumination.

5. The device of claim 4, wherein said processor comprises a histogram analyzer utility operable to determine said data indicative of the illumination type by analyzing data indicative of a spectral histogram of at least a part of the image data.

6. The device of claim 5, wherein said analyzing of the data indicative of the spectral histogram comprises determining at least one ratio between histogram parameters of at least one pair of different-color pixels in at least a part of said image stream.

7. The device of claim 6, wherein said processor utility comprises a first parameter calculation module operable to process data indicative of said at least one ratio and identify the illumination type as corresponding to the artificial illumination if said ratio is higher than a predetermined threshold, and as the natural illumination if said ratio is lower than said predetermined threshold.

8. The device of claim 2, wherein said data indicative of the ratio between the pixel size and unit dimension of the region of interest comprises a map of values of said ratio corresponding to different groups of pixels corresponding to different zones within a frame of said image stream.

9. The device of claim 1, wherein said processor utility comprises a foreground extraction module which is configured and operable to process and analyze the data indicative of said image stream to extract data indicative of foreground blobs corresponding to objects in said scene of the region of interest, and a gradient detection module which is configured and operable to process and analyze the data indicative of said image stream to determine an image gradient within a frame of the image stream.

10. The device of claim 9, wherein said processor utility is configured and operable for processing data indicative of the foreground blobs by applying thereto a filtering algorithm based on a distance between the blobs, the blob size and its location.

11. The device of claim 9, wherein said processor utility comprises a second parameter calculation module operable to analyze said data indicative of the foreground blobs and data indicative of the image gradient, and select at least one model from a set of predetermined models fitting with at least one of said foreground blobs, and determine at least one parameter of a corresponding object.

12. The device of claim 11, wherein said at least one parameter of the object comprises at least one of an average size and shape of the object.

13. The device of claim 11, wherein said second parameter calculation module operates for said selection of the model fitting with at least one of said foreground blobs comprises based on either a first or a second imager orientation mode with respect to the scene in the region of interest.

14. The device of claim 13, wherein said second parameter calculation module operates to identify whether there exists a fitting model for the first imager orientation mode, and upon identifying that no such model exists, operating to select a different model based on the second imager orientation mode.

15. The device of claim 13, wherein the first imager orientation mode is an angled orientation, and the second imager orientation mode is an overhead orientation.

16. The device of claim 15, wherein the angled orientation corresponds to the imager position such that a main axis of the imager's field of view is at a non-zero angle with respect to a certain main plane.

17. The device of claim 15, wherein the overhead orientation corresponds to the imager position such that a main axis of the imager's field of view is substantially perpendicular to the main plane.

18. The device of claim 16, wherein the main plane is a ground plane.

19. An automatic calibration device for use in a surveillance system for event detection, the calibration device comprising a data processor utility configured and operable for receiving image data indicative of an image stream of a scene in a region of interest, processing and analyzing said image data, and determining at least one calibration parameter including at least one of the imager related parameter and the scene related parameter.

20. An imager device comprising: a frame grabber for acquiring an image stream from a scene in a region of interest, and the calibration device of claim 1.

21. A calibration method for automatically determining one or more calibration parameters for calibrating a surveillance system for event detection, the method comprising: receiving image data indicative of an image stream of a scene in a region of interest, and processing and analyzing said image data for determining at least one of the following parameters: a ratio between a pixel size in an acquired image and a unit dimension of the region of interest; orientation of a field of view of said at least one imager in relation to at least one predefined plane within the region of interest being imaged; and illumination type of the region of interest while being imaged.

22. A method for use in event detection in a scene, the method comprising: (i) operating the calibration device of claim 1 and determining one or more calibration parameters including at least camera-related parameter; and (ii) using said camera-related parameter for differentiating between different types of objects in the scene.
